(19) United States
(12) Patent Application Publication
(10) Pub. No.: US 2015/0036588 A1
(43) Pub. Date: Feb. 5, 2015

(54) METHOD AND APPARATUS FOR MULTIPLEXING PACKET TO EXTEND WIRELESS SENSOR NETWORK USING EXISTING TRANSMISSION NETWORK

(71) Applicant: ELECTRONICS AND TELECOMMUNICATIONS RESEARCH INSTITUTE, Daejeon (KR)

(72) Inventors: Tae Joon Park, Daejeon (KR); Chang Sub Shin, Daejeon (KR); Wun-Cheol Jeong, Daejeon (KR); Hoyong Kang, Daejeon (KR); IN HWAN LEE, Daejeon (KR); CHEOL SIG PYO, Daejeon (KR)

(73) Assignee: ELECTRONICS AND TELECOMMUNICATIONS RESEARCH INSTITUTE, Daejeon (KR)

(21) Appl. No.: 14/065,723

(22) Filed: Oct. 29, 2013

(30) Foreign Application Priority Data
Jul. 31, 2013 (KR) 10-2013-0091109

(51) Int. Cl. H04W 28/06; H04W 40/02; H04L 12/741; H04W 84/18

(52) U.S. Cl. CPC H04W 28/065; H04W 84/18; H04W 40/02; H04L 45/74
USPC 370/328

(57) ABSTRACT

In a wireless sensor network, it is determined whether to multiplex a packet that is generated in a random node. When a packet is to be multiplexed, by multiplexing at least one packet, a frame of a first length is generated and transmitted. The frame of the first length includes a payload in which at least one of data portions including a header unit and a data unit having a second length smaller than the first length is multiplexed.

### CROSS-REFERENCE TO RELATED APPLICATION

This application claims priority to and the benefit of Korean Patent Application No. 10-2013-0091109 filed in the Korean Intellectual Property Office on Jul. 31, 2013, the entire contents of which are incorporated herein by reference.

### BACKGROUND OF THE INVENTION

(a) Field of the Invention

The present invention relates to a method and apparatus that can use an existing transport network so as to extend a wireless sensor network, and that can multiplex and transmit a packet.

(b) Description of the Related Art

In general, most packets that are transported through an existing wireless network are short data of less than 127 bytes, that have directionality, and that are transported to a predetermined path. According to an increasing trend of using sensor nodes that generate data in a wireless sensor network, a quantity of data that are transmitted/received through a network is rapidly increasing. Therefore, in order to effectively enlarge a network according to extension of a sensor network service area, a necessity to effectively use an existing transport network is increasing.

However, because an existing transport network is optimized for an existing service, it is inefficient to use the existing transport network as a transport network for a wireless sensor network having a short length and a small data amount. For example, in a wireless sensor network, a small amount of data occurs in a large number of nodes, and the amount of data is not large, but when a transmitting/receiving terminal processes a large number of packets, the load is large. However, in an existing service, a relatively large amount of data occurs in a small number of nodes compared with a wireless sensor network, and thus a wireless sensor network represents a different characteristic from a service of an existing network in which the number of packets is relatively small and in which a size of a packet is large.

Because performance of a packet network service is more sensitive to the number of packets that should be processed than an absolute amount of data, such a phenomenon may become a serious problem. Therefore, because a sudden increase of the number of packets in a wireless sensor network adds a burden to various functions that an existing transport network does not consider, it is difficult to use the wireless sensor network as an effective transport network.

### SUMMARY OF THE INVENTION

The present invention has been made in an effort to provide a method and apparatus for multiplexing a wireless sensor network packet having advantages of efficiently transporting wireless sensor network data using an existing transport network.

An exemplary embodiment of the present invention provides a method of multiplexing a packet in a wireless sensor network, the method including: determining whether to multiplex a packet that is generated in a node constituting the wireless sensor network; generating, if the packet is to be multiplexed, a frame of a first length by multiplexing at least one packet; and transmitting the frame of the first length, wherein in the frame of the first length, a data portion including a data unit and a header unit having a second length smaller than the first length includes at least one multiplexed payload.

The determining of whether to multiplex may include determining that multiplexing of a packet is to be performed when the packet is transmitted through a transport network that is connected to the wireless sensor network, and determining that multiplexing of a packet is to be performed when the packet is directly transmitted between nodes constituting the wireless sensor network instead of being transmitted through the transport network.

Packet transmission through the transport network may include transmission of a packet between nodes through a transport network instead of being transmitted through a gateway and transmission of a packet between nodes through a gateway.

The generating of a frame of a first length may include generating a frame of the first length by multiplexing packets having the same destination address. The frame of the first length may be a management MAC packet data unit (L-MPDU), and the data unit of the second length may be an S-MPDU. The frame of the first length may further include a first frame header portion including information that is related to the payload, a second header portion including length information of the frame, and a frame check sequence (FCS) for checking an error. The frame may be formed in order of the second header portion, the first header portion, the payload, and the FCS, and the first length may represent a length from the first header portion to the FCS.

Another embodiment of the present invention provides a packet multiplexing apparatus in a wireless sensor network, the packet multiplexing apparatus including: a packet generator that generates a packet corresponding to data to be transmitted in a random node constituting a wireless sensor network; a multiplexing determination unit that determines whether a packet is to be transmitted through a transport network and that determines whether to multiplex; a packet multiplexer that multiplexes at least one packet that is determined to be multiplexed; and a packet transmitter that generates and transmits a frame including the multiplexed packet, wherein the frame has a first length and includes at least one data portion including a data unit having a second length smaller than the first length and a header unit that is related to the data unit.

The packet multiplexer may multiplex packets having the same destination address. The multiplexing determination unit may determine whether a corresponding packet is a packet to be transmitted through transport network transmission based on a destination address of the packet.

### BRIEF DESCRIPTION OF THE DRAWINGS

FIG. 1 is a diagram illustrating a structure of a packet frame according to an exemplary embodiment of the present invention.

FIG. 2 is a diagram illustrating a wireless network environment in which a multiplexing method is applied according to an exemplary embodiment of the present invention.

FIG. 3 is a flowchart illustrating a method of multiplexing a packet according to an exemplary embodiment of the present invention.

FIG. 4 is a block diagram illustrating a configuration of a packet multiplexing apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for multiplexing a packet in a wireless sensor network according to an exemplary embodiment of the present invention will be described.

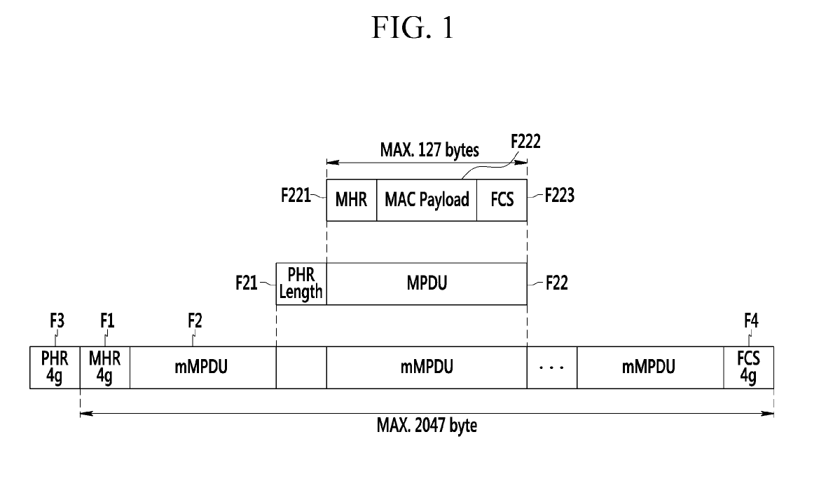

FIG. 1 is a diagram illustrating a structure of a packet frame according to an exemplary embodiment of the present invention.

A frame according to an exemplary embodiment of the present invention includes a first header portion F1 and a payload portion F2 including at least one data portion, and further includes a second header portion F3 and a frame check sequence (FCS) portion F4 for checking an error.

Such a packet frame has a first length, and the first header portion F1 includes information that is related to the payload portion F2 and is referred to as a MAC header (MHR).

The payload portion F2 includes a plurality of data portions, and is referred to as a MAC payload. Each data portion (for convenience of description, F2 is a representative reference numeral) constituting the payload portion is referred to as a management MAC packet data unit (mMPDU). Each data portion includes a header unit F21 and a data unit F22 including length information, as shown in FIG. 1. The data unit F22 is referred to as an MPDU and includes a MAC header F221, a MAC payload F222, and an FCS F223. Such a data unit F22 has a second length.

The second header portion F3 includes information about a frame length. The second header portion F3 is referred to as a PHY header (PFR). The first length is a length from the first header portion F1 to the FCS F4, except for the second header portion F3 that is positioned at the forefront of a frame.

In an exemplary embodiment of the present invention, as shown in FIG. 1, by multiplexing a plurality of data units having a second length, a packet frame having the first length is formed.

A maximum length of an MPDU was generally limited to about 127 bytes, but recently, may be extended to 2047 bytes. A maximum MDPU of the first length (e.g., about 2047 bytes) is referred to as an L-MPDU, and a maximum MPDU of the second length (e.g., about 127 bytes) is referred to as an S-MPDU.

In an exemplary embodiment of the present invention, an S-MPDU of the first length is multiplexed by an L-MPDU of the second length, and a multiplexed target is a header unit and a data unit. As shown in FIG. 1, within a limit that does not exceed the first length, a data unit S-MPDU having a plurality of second lengths is multiplexed to a MAC payload.

Table 1 represents a MAC frame type in which a method of multiplexing a packet according to an exemplary embodiment of the present invention is applied.

TABLE 1

| Frame type value | |
|---|---|
| b₂ b₁ b₀ | Remarks |
| 0 0 0 | Beacon |
| 0 0 1 | Data |
| 0 1 0 | ACK |
| 0 1 1 | MAC command |
| 1 0 0 | Aggregated MPDU |
| 101-111 | Reserved |

A kind of a frame according to an exemplary embodiment of the present invention may be classified like Table 1 according to a frame type value. Specifically, the kind of a frame includes a beacon frame (b₂, b₁, b₀: 000) for transmitting/receiving a beacon, a data frame (b₂, b₁, b₀: 001) for transmitting/receiving data, an acknowledgment (ACK) frame (b₂, b₁, b₀: 010) for determining whether data reception has succeeded, and a frame (b₂, b₁, b₀: 011) for a MAC command, and includes an L-MPDU of a first length, i.e., an aggregated MPDU frame (b₂, b₁, b₀: 100) that is formed by multiplexing an S-MPDU of at least one second length according to an exemplary embodiment of the present invention.

The aggregated MPDU frame (b₂, b₁, b₀: 100) according to an exemplary embodiment of the present invention includes a first header portion F1, which is a MAC header, and a payload portion F2 including at least one data portion, as shown in FIG. 1.

Hereinafter, a method of multiplexing a packet using such a frame will be described.

Upon multiplexing a packet, when final destination addresses of each packet are the same, the packet may be multiplexed, and when next hops of each packet are the same, the packet may be multiplexed. In a case of the latter, a switching function of disassembling and reassembling in every hop is necessary, and thus as complexity increases, in an exemplary embodiment of the present invention, when final destination addresses are the same, an example of performing multiplexing is described. However, the present invention is not limited thereto. A standby time for multiplexing is determined according to an allowance delay time request condition of a service.

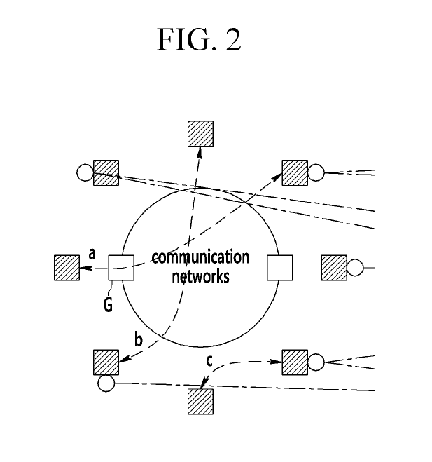

FIG. 2 is a diagram illustrating a wireless network environment in which a multiplexing method is applied according to an exemplary embodiment of the present invention.

As shown in FIG. 2, a plurality of nodes communicate through a network or directly. Specifically, in FIG. 2, a case “c” is a case in which a direct connection between nodes, which are constituent elements of a wireless sensor network, is performed, and information of nodes is gathered and is directly transported to a server for processing data through a backhaul network of a sensor network without passing through another transport network.

A case “b” of FIG. 2 uses an existing transport network for extension of a wireless sensor network. Data is directly transported to nodes through a transport network instead of passing through a separate gateway using an address system used in an existing network, such as an IP address system. In this case, in a packet of a short length occurring in relatively many nodes, an inefficient address system and a load that is not estimated in an existing transport network may occur. In an exemplary embodiment of the present invention, as in the case “b”, when a packet is transmitted/received between nodes through an existing transport network, the packet is multiplexed. Therefore, the case “b” may become a good alternative of sensor network backhaul that applies long length data of a maximum of 2047 bytes.

The case “a” of FIG. 2 uses an existing transport network so as to extend a wireless sensor network, and a packet is transmitted/received between nodes through a separate gateway G of the transport network. In this case, there is no processing burden of an address system of a sensor network according to transmission/reception through a gateway G, but a process of converting an address with an address system used in an existing network is requested, such as an IP address. Therefore, a short length of packets occurring in relatively many nodes may aggravate an inefficient address system, and a processing load that is not estimated in an existing transport network may occur. In an exemplary embodiment of the present invention, as in the case “a”, when a packet is transmitted/received between nodes through a gateway of an existing transport network, the packet is multiplexed.

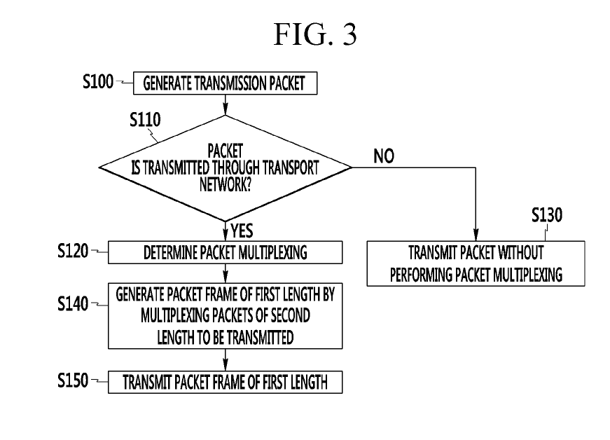

FIG. 3 is a flowchart illustrating a method of multiplexing a packet according to an exemplary embodiment of the present invention.

A packet having occurred in a node constituting a sensor network is data having a short length, and in an exemplary embodiment of the present invention, by multiplexing data instead of repeatedly transmitting data several times, data is processed and transmitted as one packet.

When a random node constituting a wireless sensor network attempts to transmit packet data to another node, a packet multiplexing apparatus determines whether a packet is transmitted through a transport network (S100 and S110). In a network environment of FIG. 2, as in cases “a” and “b”, when a packet is transmitted through a transport network, a packet multiplexing apparatus multiplexes the packet (S120). However, when a packet is directly transmitted between nodes like the case “c” instead of through a transport network, the packet multiplexing apparatus does not multiplex the packet (S130). A method of determining whether a packet is transmitted through a transport network may use an address of a packet. For example, when a destination address system of a packet follows an address system of a transport network, it is determined that the corresponding packet is transmitted through the transport network.

When packet multiplexing is performed, by multiplexing packets to be transmitted, a packet frame is generated. That is, by multiplexing at least one of data portions including a data unit, which is a packet having a second length, and a header unit that is related thereto, the payload portion F2 is generated (S140). Here, destination addresses of multiplexed data portions are the same.

By multiplexing at least one of data portions having a data unit of the second length, the payload portion F2 is formed, and by coupling a first header portion F1 including information that is related thereto, a frame of the first length to be transmitted is generated. The generated frame of the first length is transmitted (S150).

A data packet of a short length is repeatedly transmitted through such a process, but by processing and transmitting with a frame of a longer length by multiplexing such data packets, in a wireless sensor network, a processing load according to a repeated transmitting/receiving processing of a packet of a small size can be reduced.

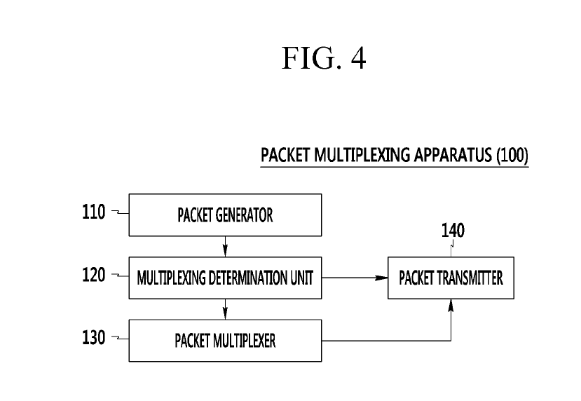

FIG. 4 is a block diagram illustrating a configuration of a packet multiplexing apparatus according to an exemplary embodiment of the present invention.

As shown in FIG. 4, a packet multiplexing apparatus 100 according to an exemplary embodiment of the present invention includes a packet generator 110, a multiplexing determination unit 120, a packet multiplexer 130, and a packet transmitter 140.

The packet generator 110 generates a packet corresponding to data to be transmitted in a random node constituting a wireless sensor network.

The multiplexing determination unit 120 determines whether a generated packet is transmitted through a transport network, and determines whether to multiplex. If a packet is directly transmitted between nodes, the multiplexing determination unit 120 determines that packet multiplexing is not to be performed, and transports the corresponding packet to the packet transmitter 140. If a packet is transmitted through the transport network, the multiplexing determination unit 120 determines that packet multiplexing is to be performed, and transports the corresponding packet to the packet multiplexer 130.

The packet multiplexer 130 multiplexes packets to be transmitted. The packet multiplexer 130 generates a payload portion by multiplexing at least one of data portions including a data unit, which is a packet having a second length, and a header unit that is related thereto, and provides the payload portion to the packet transmitter 140. Destination addresses of the multiplexed data portions may be the same.

The packet transmitter 140 generates a frame by coupling a header portion including related information to a packet to be transmitted, and transmits the generated frame. Particularly, the packet transmitter 140 multiplexes at least one of data portions having a data unit of a second length that is transported from the packet multiplexer 130, and generates and transmits a frame of the first length by coupling the first header portion including related information to a generated payload portion.

According to an exemplary embodiment of the present invention, data of a wireless sensor network can be effectively transported through an existing transport network. Therefore, a service can be extended using an existing transport network. Further, when forming a network with only a wireless sensor network, wireless sensor network backhaul can be formed, and when a transport network connection for extending a service is necessary, an effective network connection is available.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from the description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of multiplexing a packet in a wireless sensor network, the method comprising:
determining whether to multiplex a packet that is generated in a node constituting the wireless sensor network;
generating, if the packet is to be multiplexed, a frame of a first length by multiplexing at least one packet; and
transmitting the frame of the first length,
wherein in the frame of the first length, a data portion comprising a data unit and a header unit having a second length smaller than the first length comprises at least one multiplexed payload.

2. The method of claim 1, wherein the determining of whether to multiplex comprises:
determining that multiplexing of a packet is to be performed when the packet is transmitted through a transport network that is connected to the wireless sensor network; and
determining that multiplexing of a packet is to be performed when the packet is directly transmitted between nodes constituting the wireless sensor network instead of being transmitted through the transport network.

3. The method of claim 2, wherein packet transmission through the transport network comprises transmission of a packet between nodes through a transport network instead of being transmitted through a gateway and transmission of a packet between nodes through a gateway.

4. The method of claim 1, wherein the generating of a frame of a first length comprises generating a frame of the first length by multiplexing packets having the same destination address.

5. The method of claim 1, wherein the frame of the first length is a management MAC packet data unit (L-MPDU), and the data unit of the second length is an S-MPDU.

6. The method of claim 1, wherein the frame of the first length further comprises a first frame header portion comprising information that is related to the payload, a second header portion comprising length information of the frame, and a frame check sequence (FCS) for checking an error.

7. The method of claim 6, wherein the frame is formed in order of the second header portion, the first header portion, the payload, and the FCS, and the first length represents a length from the first header portion to the FCS.

8. A packet multiplexing apparatus in a wireless sensor network, the packet multiplexing apparatus comprising:
a packet generator that generates a packet corresponding to data to be transmitted in a random node constituting a wireless sensor network;
a multiplexing determination unit that determines whether a packet is to be transmitted through a transport network and that determines whether to multiplex;
a packet multiplexer that multiplexes at least one packet that is determined to be multiplexed; and
a packet transmitter that generates and transmits a frame comprising the multiplexed packet,
wherein the frame has a first length and comprises at least one data portion comprising a data unit having a second length smaller than the first length and a header unit that is related to the data unit.

9. The packet multiplexing apparatus of claim 8, wherein the packet multiplexer multiplexes packets having the same destination address.

10. The packet multiplexing apparatus of claim 8, wherein the multiplexing determination unit determines whether a corresponding packet is a packet to be transmitted through transport network transmission based on a destination address of the packet.
